(19) United States
(12) Patent Application Publication
(10) Pub. No.: US 2010/0177037 A1
(43) Pub. Date: Jul. 15, 2010

(54) APPARATUS AND METHOD FOR MOTION DETECTION IN A PORTABLE TERMINAL

(75) Inventors: Jae-Ho KIM, Daegu (KR); Sung-Pil CHO, Gyeonggi-do (KR); Chang-Yul LEE, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/684,222

(22) Filed: Jan. 8, 2010

(30) Foreign Application Priority Data
Jan. 9, 2009 (KR) 10-2009-0001901

(51) Int. Cl. G09G 5/00; G01P 15/00; G01C 17/00

(52) U.S. Cl. 345/156; 73/488; 33/355 R

(57) ABSTRACT

An apparatus and method for motion detection in a portable terminal preferably includes a state determination unit for receiving first sensing information for determining a motion of the portable terminal by a sensor unit. After determining the motion of the portable terminal, second sensing information is received for determining whether or not a normal motion applying a motion function has occurred. The portable terminal determines if the portable terminal is a normal motion associated with a motion-related function or an abnormal motion that is not associated with a motion-related function.

### CLAIM OF PRIORITY

This application claims the benefit of priority under 35 U.S.C. §119 from a Korean patent application filed in the Korean Intellectual Property Office on “Jan. 9, 2009” and assigned Serial No. “10-2009-0001901”, the entire disclosure of which is hereby incorporated by reference in its entirety.

### BACKGROUND OF THE INVENTION

1. Field of the Invention

The present invention relates to an apparatus and method for enabling a user of a portable terminal to control the portable terminal using a motion detection function. More particularly, the present invention relates to a motion function providing apparatus and method in a portable terminal for detecting a motion of the portable terminal.

2. Description of the Related Art

Portable terminals, such as mobile communication terminals, Personal Digital Assistants (PDAs), etc. are in vogue and their use has rapidly increase because of the convenience that such functionality and portability provides. Thus, service providers (i.e., terminal manufacturers) are competing to develop portable terminals having additional convenient functions so as to secure more purchasers and users of their equipment and services.

For example, current portable terminals are now capable providing functions of a phonebook, a game, a scheduler, a Short Message Service (SMS), a Multimedia Message Service (MMS), a Broadcast Message Service (BMS), an Internet service, an electronic mail (e-mail), a wake-up call, an MPEG-1 Audio Layer 3 (MP3), a digital camera, and the like.

In addition, current portable terminals can be made to interpret a motion and tilt of the terminal itself as a way to manipulate the portable terminal without depending on only a keypad comprised of buttons, a touch screen, and the like.

For example, a portable terminal with a motion detector can delete a spam phone number or spam message by user's shaking the terminal twice up/down, enable speed dialing of a corresponding number and make a call by user's making a motion to draw the number with the portable terminal, and obtain sound effects of playing a musical instrument such as a tambourine or a variety of beat boxes by user's shaking the terminal in a concert hall or nightclub or anywhere while listening to music. Also, in a motion mode, the portable terminal can automatically output a saying of “Oh Yes” by user's imaging ‘O’ with the portable terminal, and can automatically output a saying of “Oh No” by user's imaging ‘X’ with the portable terminal. In addition, a user can select other music by simply moving the portable terminal left/right in an MP3 mode. Also, these motions can be applied to and used for a step counter, a game, etc.

When playing games with the portable terminal using the motion detector, a motion and a tilt of the portable terminal itself can be added to permit manipulation of the a game manipulation, in lieu of, for example, a separate joystick or hand-held controller. By this feature, even when conducting reading with the portable terminal, a user can conduct the reading by tilting the terminal without use a scroll button. In addition, more new games have been developed for portable terminals that now take advantage of the motion detection of the terminal itself.

Thus, the motion detection function is applicable to a plurality of functions of the portable terminal, thus providing a convenience to a user.

However, there is a problem because although the motion detection function is a function of detecting movement of the portable terminal using information on a tilt variation of orientation of the portable terminal, and/or an acceleration variation, etc., even when there is an abnormal motion of the portable terminal, the portable terminal may perform an operation corresponding to the abnormal motion detected.

For one example, a user can operate the motion detection function by moving the portable terminal, but there is a problem that, if a motion variation of the portable terminal is inadvertently generated in a user's bag or pocket, the portable terminal may perform a motion function corresponding to the motion.

### SUMMARY OF THE INVENTION

An exemplary aspect of the present invention is to provide an apparatus and method for enabling a user of a portable terminal to control the portable terminal using a motion detection function.

Another exemplary aspect of the present invention is to provide an apparatus and method for motion detection in a portable terminal with improved accuracy.

The above exemplary aspects are achieved by providing an apparatus and method for motion detection in a portable terminal according to the presently claimed invention.

In accordance with an exemplary aspect of the present invention, an apparatus for motion detection in a portable terminal preferably includes a sensor unit containing first sensors for sensing a motion of the portable terminal has occurred and second sensors for determining a type of motion; and a state determination unit for receiving first sensing information from said first sensors for determining whether a motion of the portable terminal from the sensor unit has been sensed, and for receiving second sensing information from said second sensors for determining whether or not the sensed motion by the second sensors comprises a normal motion for applying a motion-related function based on a motion determination rate of the portable terminal, in order to determine if a state of motion of the portable terminal comprises the normal motion or an abnormal motion that is unrelated to functionality.

In accordance with another aspect exemplary aspect of the present invention, a method for motion detection in a portable terminal preferably includes, if receiving sensing information from a plurality of sensors, determining a motion of the portable terminal using first sensing information for determining the motion of the portable terminal, and, determining if the portable terminal is in a normal motion or an abnormal motion using second sensing information for determining whether the normal motion is to be applied as a motion function or not.

Other exemplary aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of the present invention will become more apparent from the following detailed description when taken in conjunction with the accompanying drawings in which:

FIG. 1 is a block diagram illustrating a construction of a portable terminal providing a motion function according to an exemplary embodiment of the present invention;

FIG. 2 is a flowchart illustrating a process of using a motion function in a portable terminal according to an exemplary embodiment of the present invention;

FIG. 3 is a flowchart illustrating a process for controlling an operation according to call reception in a portable terminal according to an exemplary embodiment of the present invention; and

FIGS. 4 4 and 4B are diagrams illustrating a process of performing a function corresponding to a terminal state in a portable terminal according to an exemplary embodiment of the present invention.

### DETAILED DESCRIPTION

The following description, with reference to the accompanying drawings, is provided to assist a person of ordinary skill in the art with a comprehensive understanding of exemplary embodiments of the invention as defined by the appended claims. The description includes various specific details to assist a person of ordinary skill the art with understanding the claimed invention, but these details are to be regarded as merely exemplary and provided for illustrative purposes. Accordingly, those of ordinary skill in the art will recognize that various changes and modifications of the illustrative examples described herein can be made without departing from the spirit of the invention and the scope of the appended claims. Also, descriptions of well-known functions and constructions may be omitted for clarity and conciseness when their inclusion could obscure appreciation of the presently claimed invention by a person of ordinary skill in the art.

The terms and words used in the following description and claims are not limited to the bibliographical meanings, but, are merely used by the inventor to enable a clear and consistent understanding of the invention as would be understood by a person of ordinary skill in the art. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

Exemplary embodiments of the present invention will now be described herein below with reference to the accompanying drawings.

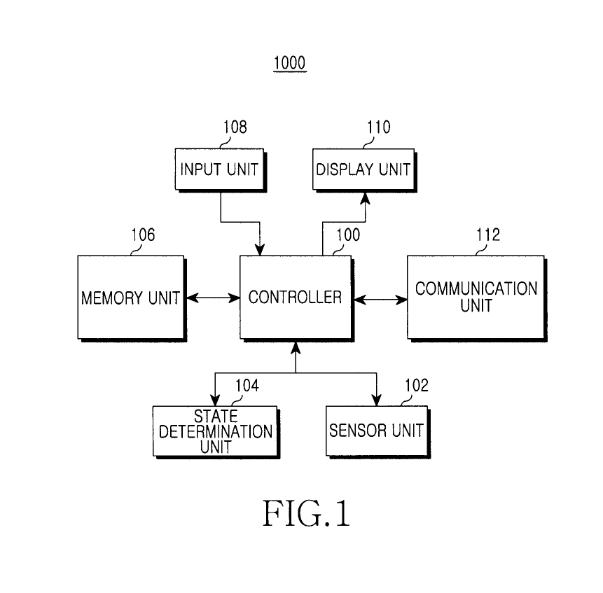

FIG. 1 is a block diagram illustrating a construction of a portable terminal providing a motion detection function according an exemplary embodiment of the present invention.

Referring now to the example shown in FIG. 1, an exemplary portable terminal 1000 according to the present invention preferably includes, for example a controller 100, a sensor unit 102, a state determination unit 104, a memory unit 106, an input unit 108, a display unit 110, and a communication unit 112.

The controller 100 of the portable terminal typically controls a general operation of the portable terminal. For example, the controller 100 performs a process and control for voice telephony and data communication. In addition to performing general functions, if receiving sensing information from the sensor unit 102 according to the present invention, the controller 100 first determines a state (i.e., motion) of the portable terminal using first sensing information and then, the controller 100 determines if the portable terminal is in a normal motion or an abnormal motion made in a user's pocket or bag, by using second sensing information. The first sensing information may determine, for example, a motion of the portable terminal, and the second sensing information may determine, for example, an accurate motion of the portable terminal (i.e., a normal motion applying a motion function) or not. The controller 100 processes information from the state determination unit 104 to determine a motion of the portable terminal.

If determining that the motion of the portable terminal to be normal motion of the portable terminal, the controller 100 functions to control/perform a function corresponding to the normal motion of the portable terminal.

Still referring to FIG. 1, the sensor unit 102 is comprised of a plurality of sensors (e.g., acceleration sensors, geomagnetic sensors, and the like) that can sense a motion of the portable terminal. The sensor unit 102 acquires information for determination of the motion of the portable terminal and provides the information to the controller 100. The sensor unit 102 includes a sensor (e.g., a light sensor, and the like.) for additionally acquiring information necessary for normal motion determination of the plurality of sensors capable of sensing a motion. Namely, the sensor unit 102 determines information for increasing a state determination rate for function control of the portable terminal and provides the information to the controller 100, thereby enabling determination of an accurate motion of the portable terminal.

The state determination unit 104 determines a type of motion of the portable terminal using the information acquired by the sensor unit 102. At this time, the state determination unit 104 first determines a state of the portable terminal using the first sensing information of sensors that determine the motion of the portable terminal. After that, the state determination unit 104 then determines if the portable terminal is in a normal state (i.e., a normal motion) for function control, or, in an abnormal state (i.e., an abnormal motion) using the second sensing information of sensors of the sensor unit 102 for determining an accurate motion of the portable terminal (i.e., sensors for increasing a motion determination rate). Abnormal motion would be motion not made to manipulate the portable terminal to perform/execute some pre-determined functionality that is associated with such movement. For example, if the user slips and falls with the phone in their hands, this sensed movement is abnormal and not made to cause the portable terminal to perform/access/execute some functionality.

The memory unit 106 preferably includes a Read Only Memory (ROM), a Random Access Memory (RAM), and a flash ROM. These types of memory are provided her in for explanatory purposes. The ROM preferably stores a microcode of a program for processing and controlling the controller 100 and a variety of kinds of reference data.

With continued reference to FIG. 1, the RAM comprises a working memory of the controller 100, and stores temporary data generated during the execution of a variety of kinds of programs. The flash ROM stores a diversity of kinds of updateable depository data such as a phone book, an outgoing message, and an incoming message.

Also, the memory unit 106 may have been pre-programmed to store a control function corresponding to a motion (i.e., a state) of the portable terminal according to the present invention.

The input unit 108 preferably includes numeral key buttons ‘0’ to ‘9’, or an equivalent of such keys, and a menu button, a cancel button (delete), an OK button, a talk button, an end button, an Internet button, navigation key (or direction key) buttons, a character input key, and the like, just to name a few possible non-limiting examples. The input unit 108 provides key input data corresponding to a key pressed by a user to the controller 100.

The display unit 110 displays, for example, information generated during an operation of the portable terminal, as well as a certain number of characters, a large amount of moving pictures and still pictures, and the like. The display unit 110 may comprise, for example, a color Liquid Crystal Display (LCD), and/or any type of thin film technology display. If the LCD is provided as a touch screen, the display unit 110 may perform a part or all of the functions of the input unit 108. Thus, the display and input unit can be a single element that provides dual-functionality.

The communication unit 112 transmits/receives and processes a radio signal of data input/output through an antenna (not shown). For example, in a transmission mode, the communication unit 112 processes original data through, for example, channel coding and spreading, converts the original data into a Radio Frequency (RF) signal, and transmits the RF signal. In a reception mode, the communication unit 112 converts a received RF signal into a baseband signal, processes the baseband signal through de-spreading and channel decoding, and restores the signal to original data. A person of ordinary skill in the art understands and appreciates the channel coding and spreading of the information is not the only protocol for the transmission of data.

A function of the state determination unit 104 can be implemented by the controller 100 of the portable terminal. However, while these items are separately constructed and shown in the present invention as an exemplary construction for description convenience, there is no limitation to the scope of the presently claimed invention to the separate items shown and described herein. It will be understood by those skilled in the art that various modifications of construction can be made within the scope of the present invention. For example, it can be also constructed for the controller 100 to process all of the functions shown in the drawings.

The above description pertains to an apparatus for enabling a user of a portable terminal to control the portable terminal using a motion detection function according to an exemplary embodiment of the present invention. The following description pertains to a method for enabling a user of a portable terminal to control the portable terminal using a motion detection function through the apparatus according to an exemplary embodiment of the present invention.

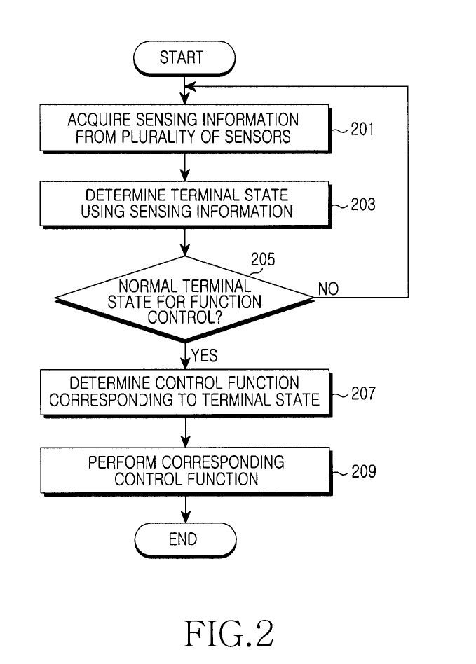

FIG. 2 is a flowchart illustrating an exemplary operation of a process of using a motion function in a portable terminal according to an exemplary embodiment of the present invention. Here, the motion function refers to a function of enabling a user of the portable terminal to control the portable terminal using a motion detection function. For example, the user of the portable terminal may change from a bell (sound) mode into a vibration mode by merely turning the terminal on its back, and discontinue playing an MP3 by rotating the terminal clockwise. At this time, the user directly sets the operation corresponding to the motion, thus being capable of performing the motion function.

Referring now to FIG. 2, in step 201, the portable terminal acquires sensing information from a plurality of sensors. Then, the method proceeds to step 203 wherein the portable terminal determines a state (i.e., a motion) of the portable terminal using the acquired sensing information. Here, the plurality of sensors represents the inclusion of first sensors and second sensors, which could include, for example sensors in the sensor unit shown in FIG. 1. The first sensors may sense a motion of the portable terminal. The second sensors may sense an increase in a motion determination rate of the portable terminal, i.e., determine a normal motion of the portable terminal. Here, the “normal motion” refers to a sensed motion that a user of the portable terminal makes to substantially trigger a motion-related function, except for an abnormal motion that may be made inadvertently as the user moves while putting the terminal into his/her pocket or bag.

Thus, the portable terminal determines the state (e.g., a state rotated clockwise, a state turned over by a user, etc.) of the portable terminal using the information sensing the motion, for example, as described above.

Then, the method proceeds to step 205 wherein the portable terminal determines whether or not a normal terminal state for function control or not has been made by the user wishing to access a motion-related function of the portable terminal. The normal state for function control refers to a process of determining that the user of the portable terminal has made a motion to control a function of the portable terminal. If the portable terminal determines the motion made not being in normal state, the portable terminal determines that the motion was an abnormal state in which the portable terminal's motion was made in a user's bag or pocket.

In order to determine an accurate motion, i.e., if the portable terminal is in a normal state for function control, or an abnormal state based on the first and second sensors, which does not specifically require a sensor that directly senses movement. For one example, the portable terminal may sense a predetermined amount of light variation using a light sensor as the second sensor capable of determining the abnormal motion and determine an abnormal state in which a motion is made in a user's pocket or bag or not. In other words, if the portable terminal is turned over in a state of sensing light using the light sensor and thus discontinues sensing light, the portable terminal determines that a user substantially has made a motion to use the function control, and detects the motion. If the portable terminal determines that before and after motion detection fail to sense light using the light sensor, the portable terminal may determine that an abnormal motion has been made in a user's pocket or bag.

Referring now to step 205, if it is determined that the portable terminal is in an abnormal state (i.e., a state in which a motion is made in a pocket or bag), the portable terminal repeatedly performs step 201.

On the other hand, if is determined that the portable terminal is in a normal state in step 205, the method proceeds to step 207 wherein the portable terminal determines a control function corresponding to the state of the portable terminal. Here, the control function corresponding to the state of the portable terminal can be directly set by a user as in Table 1 below or can be defined in a process of manufacturing the portable terminal.

TABLE 1

| Terminal state | Control function |
|---|---|
| Turning over front to back | From bell mode to mute mode |
| Turning over back to front | From mute mode to bell mode |
| Turning over and then returning | Power off |
| to original state (i.e., twice | |
| turning over) | |

Among the states of the portable terminal shown in Table 1 above, a state of turning over and then returning to the original state (i.e., twice overturning) is a state of, after detecting a motion through a motion sensor capable of sensing a motion of the portable terminal, repeating a process of sensing light through a light sensor and a process of not sensing light. This state improves the accuracy of determining the state of the portable terminal.

Then, at step 209 the portable terminal performs the control function determined in step 207 and then, terminates the process according to the exemplary embodiment of the present invention.

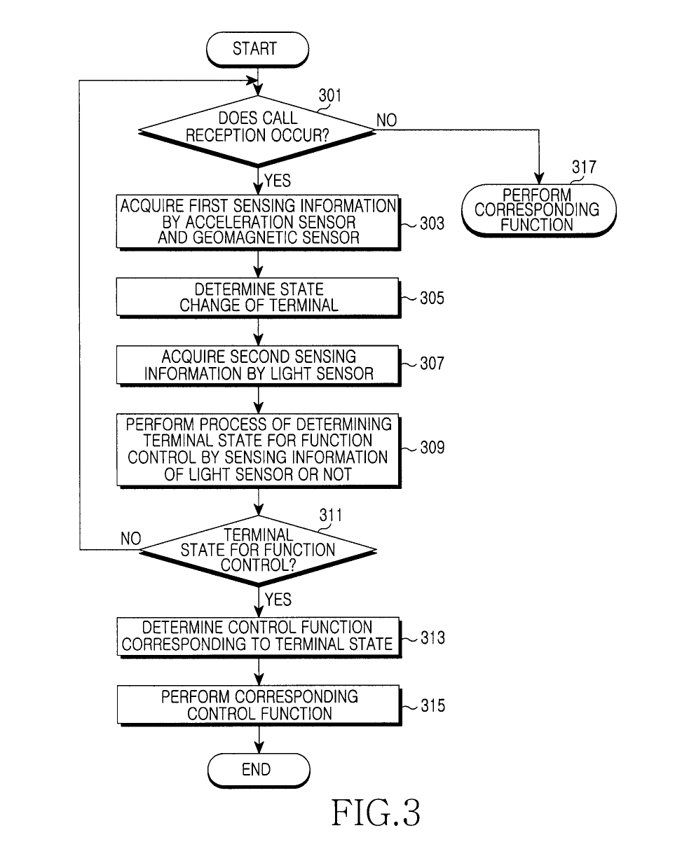

FIG. 3 is a flowchart illustrating exemplary operation of a process for controlling an operation according to call reception in a portable terminal according to an exemplary embodiment of the present invention.

Referring now to FIG. 3, in step 301, the portable terminal determines if call reception occurs. If the call reception does not occur in step 301, the method proceeds to step 317 wherein the portable terminal performs a corresponding function (e.g., goes into or remains in an idle mode).

On the other hand, if the portable terminal determines at step 301 that the call reception has occurred, the method proceeds to step 303 and the portable terminal acquires sensing information using an acceleration sensor and/or a geomagnetic sensor. Here, the acceleration sensor and geomagnetic sensor acquire first sensing information for determining a motion of the portable terminal.

Then, at step 305 the portable terminal determines a state change by using the first sensing information acquired in step 303. Then, at step 307, the portable terminal acquires the second sensing information from a light sensor. More particularly, the second sensing information of the light sensor at step 307 refers to information for accurately determining a state change of the portable terminal. That is, the portable terminal determines a normal state change of the portable terminal for function control, or an abnormal state change, based on the second sensing information of the light sensor.

With continued reference to FIG. 3, at step 309 the portable terminal performs a process of finally determining if the state of the portable terminal determined through the first sensing information of the acceleration sensor and geomagnetic sensor is equal to a normal state of the portable terminal for a function control of the portable terminal by using the second sensing information of the light sensor. Then, at step 311 the portable terminal determines the determination result of step 309.

If the portable terminal determines that its state is not equal to the normal state for function control, that is, if the portable terminal determines at step 311 that an abnormal motion was made in a user's pocket or bag, the method returns to step 301, wherein portable terminal performs the steps again. Namely, the portable terminal proceeds to step 301 and generates an alarm (i.e., a sound, visual indication, tactile indication, etc.) according to call reception, informing a user of the occurrence of call reception.

On the other hand, if it is determining that the state of the portable terminal is equal to the normal state for function control, that is, if determining at step 311 that a user has made a motion to control a function of the portable terminal, the portable terminal determines a control function (e.g., an automatic answering mode, a reception reject, etc.) corresponding to the normal state of the portable terminal. Then, at step 315 the portable terminal performs the specific control function determined in step 313.

Subsequently, the portable terminal terminates the process according to this particular exemplary embodiment of the present invention.

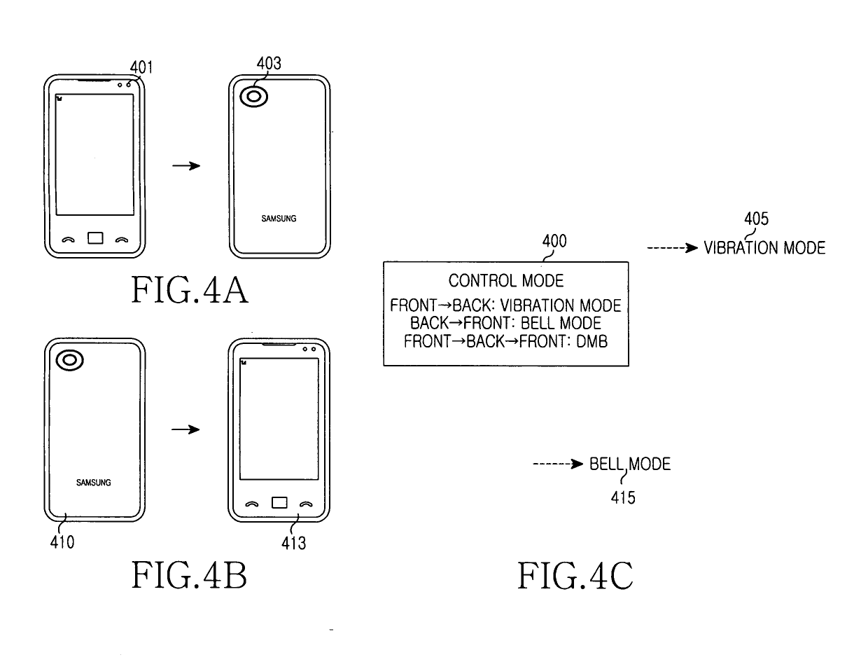

FIGS. 4A and 4B are diagrams illustrating a process of performing a function corresponding to a terminal state in a portable terminal according to an exemplary embodiment of the present invention.

FIG. 4A illustrates an exemplary process of determining a terminal state for function control in a portable terminal according to an exemplary implementation of the present invention.

As illustrated in FIG. 4A, in case that a user turns the portable terminal putting upward its front exposing a light sensor 401 and a screen on its back exposing a camera 403, the portable terminal may first determine that it is turned over front to back using a geomagnetic sensor and an acceleration sensor. At this time, the portable terminal may determine that a user of the portable terminal turned over the terminal for the sake of function control on the basis of the sensing information of the light sensor, in order to make an accurate determination of a motion of the portable terminal for function control. For example, if the portable terminal is turned over from the front exposing the light sensor 401 to the back, at the same time when the portable terminal is turned over in a state of sensing light, the portable terminal discontinues sensing light. By this, the portable terminal determines that the portable terminal is turned over according to a user's intention and enables accurate determination of a motion of the portable terminal for function control. Although the portable terminal is turned over front to back as above, if there is not a variation of sensing of light by use of the light sensor, the portable terminal determines that a motion is made in a user's pocket or bag as a user moves, and determines that it is not a motion for function control.

FIG. 4B illustrates another exemplary process of determining a terminal state for function control in a portable terminal according to another exemplary implementation of the present invention.

As illustrated in FIG. 4B, in case that a user turns the portable terminal 410 so as to place upward the back of the portable terminal exposing a camera on its front (as indicated by reference numeral 413), the portable terminal may first determine that it has been turned over back to front using a geomagnetic sensor and an acceleration sensor. At this time, the portable terminal may determine that a user of the portable terminal turns over the terminal for the sake of function control using sensing information of the light sensor in order to accurately determine a motion of the portable terminal for function control. For example, if the portable terminal is turned over from the back not exposing a light sensor to the front, at the same time when the portable terminal is turned over in a state of not sensing light, the portable terminal begins to sense light. By this change, the portable terminal determines that the portable terminal is turned over according to a user's intention and enables accurate determination of a motion of the portable terminal for function control. Although the portable terminal is turned over back to front as above, if there is no variation of sensing of light by use of the light sensor, the portable terminal determines that a motion is made in a user's pocket or bag as a user moves, and determines that it is not a motion for function control (e.g. an abnormal motion).

Thus, if the portable terminal detects its state (i.e., motion) for function control, the portable terminal determines a preset control function of the portable terminal by state and thus, performs the control function.

For example, in case that, as denoted by reference numeral 400, the portable terminal is set to change into a vibration mode when a user turns the portable terminal putting its front upward on its back, change into an audible mode when the user turns the portable terminal putting its back upward on its front, and view Digital Multimedia Broadcasting (DMB) when the user turns the portable terminal putting its front upward on its back and then again turns the portable terminal on its front, the portable terminal of FIG. 4A changes into the vibration mode as denoted by reference numeral 405.

The portable terminal of FIG. 4B also changes into the audible mode as denoted by reference numeral 415.

In case that call reception occurs during a busy work or a conference, a user of a portable terminal applying the above method may easily, quickly change an operation mode by just changing the portable terminal in direction in place of manipulating a separate key such as a side key to change a bell mode into either a vibration mode or an automatic answering mode.

As described above, an exemplary embodiment of the present invention provides an apparatus and method for enabling a user of a portable terminal to control the portable terminal using a motion detection function. More particularly, an exemplary embodiment of the present invention may determine an abnormal motion made in a user's pocket or bag by detecting a motion of the portable terminal using an acceleration sensor to improve the accuracy of a motion detection function in the portable terminal, sensing light with a light sensor, and determining a position of the portable terminal using a sensing variation of light, thus improving the accuracy of motion determination.

While the invention has been shown and described with reference to certain preferred exemplary embodiments thereof, it will be understood by those skilled in the art that various changes in form and details may be made therein without departing from the spirit and scope of the invention as defined by the appended claims.

What is claimed is:

1. An apparatus for motion detection in a portable terminal, the apparatus comprising:
a sensor unit containing first sensors for sensing a motion of the portable terminal has occurred and second sensors for determining a type of motion; and
a state determination unit for receiving first sensing information from said first sensors for determining whether a motion of the portable terminal from the sensor unit has been sensed, and for receiving second sensing information from said second sensors for determining whether or not the sensed motion by the second sensors comprises a normal motion for applying a motion-related function based on a motion determination rate of the portable terminal, in order to determine if a state of motion of the portable terminal comprises the normal motion or an abnormal motion that is unrelated to functionality.

2. The apparatus of claim 1, further comprising a controller for controlling performance of a control function corresponding to the motion-related function, if determining the state of motion of the portable terminal comprises normal motion of the portable terminal.

3. The apparatus of claim 1, wherein the sensor unit is comprises a plurality of sensors including any one of a light sensor, an acceleration sensor, and a geomagnetic sensor.

4. The apparatus of claim 1, wherein the first sensing information for determining the motion of the portable terminal has occurred comprises any one of acceleration information and geomagnetic information.

5. The apparatus of claim 1, wherein the second sensing information for determining whether or not the sensed motion by the second sensors comprises a normal motion for applying a motion-related function or not is equal to light sensing information.

6. The apparatus of claim 5, wherein the second sensing information is equal to sensing information increasing the motion determination rate of the portable terminal.

7. The apparatus of claim 2, wherein the controller controls performance of a plurality of control functions of the portable terminal based on a terminal state as shown in the following table:

| TERMINAL STATE | CONTROL FUNCTION |
|---|---|
| Turning over front to back | From bell mode to mute mode |
| Turning over back to front | From mute mode to bell mode |
| Turning over and then returning | Power off |
| to original state | |

8. The apparatus according to claim 1, wherein the sensor unit comprises an acceleration sensor and a geomagnetic sensor to acquire the first sensing information.

9. The apparatus according to claim 2, wherein the control functions include an automatic answering mode, and a reception reject.

10. A method for motion detection in a portable terminal, the method comprising:
if receiving sensing information from a plurality of sensors, determining whether motion of the portable terminal has occurred using first sensing information received from at least a first sensor of said plurality of sensors; and
determining if the motion of portable terminal sensed is a normal motion corresponding to application of a motion-related function or an abnormal motion not associated with a motion-related function using second sensing information received from a second sensor of said plurality of sensors.

11. The method of claim 10, further comprising, if determining the motion of the portable terminal to be a normal motion related to a motion-related function, processing to perform a control function corresponding to the motion.

12. The method of claim 10, wherein the plurality of sensors comprise any one of a light sensor, an acceleration sensor, and a geomagnetic sensor.

13. The method of claim 10, wherein the first sensing information for determining whether motion of the portable terminal has occurred by the first sensor comprises any one of acceleration information and geomagnetic information.

14. The method of claim 10, wherein the second sensing information for determining whether or not motion comprises normal motion related to a motion-related function is equal to light sensing information.

15. The method of claim 14, wherein the second sensing information is equal to sensing information increasing a motion determination rate of the portable terminal.

16. The method according to claim 10, further comprising a controller controlling performance of a plurality of control functions of the portable terminal based on a terminal state as shown in the following table:

| TERMINAL STATE | CONTROL FUNCTION |
|---|---|
| Turning over front to back | From bell mode to mute mode |
| Turning over back to front | From mute mode to bell mode |
| Turning over and then returning | Power off |
| to original state | |
